(19) United States
(12) Patent Application Publication
(10) Pub. No.: US 2024/0316473 A1
(43) Pub. Date: Sep. 26, 2024

(54) INFLATABLE PUMPKIN APPARATUS

(71) Applicants: Jennnifer Couch, Houston, TX (US); Amberly Hall, Houston, TX (US); Kristy Moore, Friendswood, TX (US)

(72) Inventors: Jennnifer Couch, Houston, TX (US); Amberly Hall, Houston, TX (US); Kristy Moore, Friendswood, TX (US)

(73) Assignee: Holiball, Inc., Houston, TX (US)

(21) Appl. No.: 18/599,529

(22) Filed: Mar. 8, 2024

Related U.S. Application Data
(60) Provisional application No. 63/491,524, filed on Mar. 21, 2023.

(51) Int. Cl. A63H 27/10

(52) U.S. Cl. CPC A63H 27/10; A63H 2027/1058; A63H 2027/1075

(57) ABSTRACT

A holiday apparatus, comprising an inflatable pumpkin shaped globe having an equatorial circumference of between 6 inches and 120 inches, an aperture that traverses the wall of the inflatable pumpkin shaped globe, the aperture allowing ingress into the interior of the inflatable pumpkin shaped globe; and a closure mechanism comprising a plug and aperture, the plug operable to be securely coupled to the aperture and operable to retain air in the inflatable pumpkin shaped globe. In an a embodiment, the plug is a ribbed stem plug.

### CROSS REFERENCE TO RELATED APPLICATION

This application claims the benefit of U.S. Provisional Application No. 63/491,524, filed Mar. 21, 2023, the contents of which are incorporated herein.

### TECHNICAL FIELD

The present invention relates to holiday ornaments.

### BACKGROUND OF THE INVENTION

The association between pumpkins and Halloween has its roots in Celtic and European folklore, particularly the ancient Celtic festival of Samhain, which marked the end of the harvest season and the beginning of winter. One significant tradition during Samhain involved carving turnips or other root vegetables into lanterns, which were placed outside homes to ward off evil spirits. These lanterns were often carved with grotesque faces and illuminated with candles. This practice served both practical and symbolic purposes, as the flickering light was believed to protect homes from wandering spirits.

When Christianity spread throughout Europe, Samhain was eventually Christianized into the holiday now known as Halloween, which retained many of the traditional customs and symbolism. However, turnips were scarce in North America, so immigrants from Ireland and Scotland adapted the tradition by using pumpkins, which were more readily available and easier to carve. The practice of carving pumpkins into lanterns, known as jack-o'-lanterns, became a popular Halloween tradition in North America during the 19th century. The association between pumpkins and Halloween was further solidified through cultural depictions in literature, art, and media, cementing the pumpkin's status as an iconic symbol of the holiday. Most pumpkins used for carving jack-o'-lanterns tend to fall within a range of approximately 20 inches to 30 inches (50 cm to 76 cm) in circumference. Actual pumpkins, like other fruits, are primarily made up of water, with a high water content accounting for much of their mass. Additionally, they contain carbohydrates, including sugars and dietary fiber.

What is desired is an inflatable Halloween or Fall decoration having a pumpkin shape made of a resilient material that is capable of being displayed indoors or outdoors and which can be internally illuminated.

### SUMMARY OF THE INVENTION

The invention is an inflatable, resilient, plastic polymer pumpkin shaped globe having an average equatorial circumference in the range of 6 inches and 120 inches for use as a holiday decoration. As used herein “average” refers to a number expressing the central or typical value in a set of data, in particular the mode, median, or (most commonly) the mean, which is calculated by dividing the sum of the values in the set by their number. In some embodiments of the invention, the measure of the outer surface of the invention may vary in circumference as one traces the equator. That is, where there is an indentation, the measure is less than where there is a corresponding ridge. The average around the equator of the invention then is the measure of the circumference assuming the equator is based on the radius from the center to the indentation (X) plus the measure of the circumference assuming the equator is based on the radius from the center of the invention to the ridge (Y) divided by 2. The formula for circumference is based on radius as follows: C=2*pi*radius. Hence: (X+Y)/2.

The invention can be deflated to allow efficient storage. The invention has several components including the inflatable pumpkin shaped globe having a stem and a closure mechanism. In an embodiment, the closure mechanism is a ribbed or threaded plug operable to be inserted into an aperture which permits air ingress into and egress out of the inflatable pumpkin globe. In one aspect, the aperture is located at or near the bottom of the inflatable pumpkin globe. In another aspect, the aperture is located proximate the top or stem of the inflatable pumpkin globe. The geometric shape of the inflatable pumpkin globe is a spheroid having a three-dimensional shape characterized by a round or oval shape with no sharp edges or corners. The inflatable pumpkin globe further comprises indentations around the circumference geometrically described as “ribs” or “ridges.” These are the raised, linear features that extend vertically from the top to the bottom of the pumpkin, giving it a segmented appearance. Geometrically, these ribs could be described as longitudinal sections or protrusions that form along the surface of the pumpkin. In an embodiment, the invention further comprises a light source operable to illuminate the inflatable pumpkin shaped globe. While the invention is directed for use as a Halloween decoration, it can be used for other occasions.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying Figures, in which:

FIG. 1 is a side-view of a first embodiment of the invention;

FIG. 2 is a top view of the first embodiment of the invention showing the stem plug installed thereon;

FIG. 3 is a bottom, perspective view of the first embodiment of the invention;

FIG. 4 is a top, perspective view of the second embodiment of the invention showing the stem plug removed from the inflatable pumpkin;

FIG. 5 is a side-view of a second embodiment of the invention;

FIG. 6 is a top view of the second embodiment of the invention showing the stem plug installed thereon;

FIG. 7 is a bottom view of the second embodiment of the invention;

FIG. 8 is a top view of the first embodiment of the invention showing the stem plug removed from the inflatable pumpkin;

FIG. 9 is a view of a ribbed stem plug used as a closure mechanism; and

FIG. 10 is a view of a ribbed stem plug used as a closure mechanism with a light source.

### DETAILED DESCRIPTION

While the making and using of the disclosed embodiments of the present invention is discussed in detail below, it should be appreciated that the present invention provides many applicable inventive concepts which can be embodied in a wide variety of specific contexts. Some features of the preferred embodiments shown and discussed may be simplified or exaggerated for illustrating the principles of the invention.

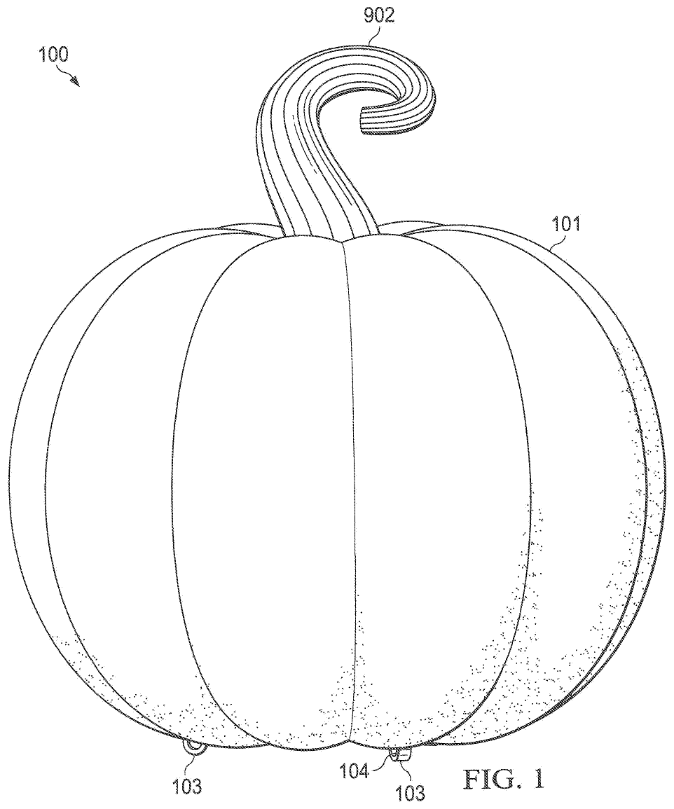

Referring now to the Figures, FIG. 1 is a side-view of a first embodiment of the invention 100 providing a more oblate spheroid shape of the invention. The invention 100 is a holiday apparatus, comprising an inflatable pumpkin shaped globe portion 101 having an average equatorial circumference of between 6 inches and 120 inches and a stem portion 902.

As used herein “average” refers to a number expressing the central or typical value in a set of data, in particular the mode, median, or (most commonly) the mean, which is calculated by dividing the sum of the values in the set by their number. In some embodiments of the invention, the measure of the outer surface of the invention may vary in circumference as one traces the equator. That is, where there is an indentation, the measure is less than where there is a corresponding ridge. The average around the equator of the invention then is the measure of the circumference assuming the equator is based on the radius from the center of the invention to the indentation (X) plus the measure of the circumference assuming the equator is based on the radius from the center of the invention to the ridge (Y), such sum divided by 2. The formula for circumference is based on radius as follows: C=2*pi*radius. Hence: (X+Y)/2. For example, if the radius of an invention from the center to an indentation is 8 inches and the radius of the invention from the center to a ridge is 10 inches, then the circumference based on the indentations is 50 and the circumference based on the ridges is 62 inches and the average circumference is 56 inches.

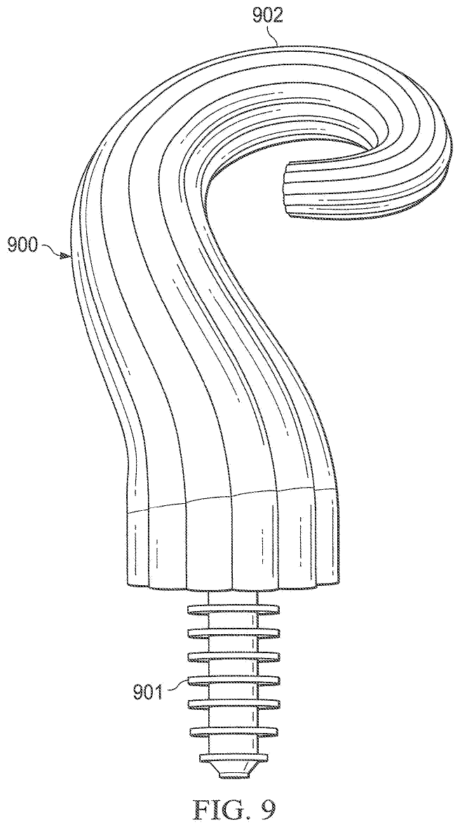

Stem portion 902 is part of stem plug 900 as seen in FIG. 9. The inflatable pumpkin shaped globe 101 has a plurality of protrusions or feet 103 proximate the base or lower portion of the inflatable pumpkin shaped globe 101. In an embodiment, the protrusions or feet 103 are equally positioned around a circumference thereof. Said protrusions have protrusion apertures 104 traversing through the planar surfaces thereof.

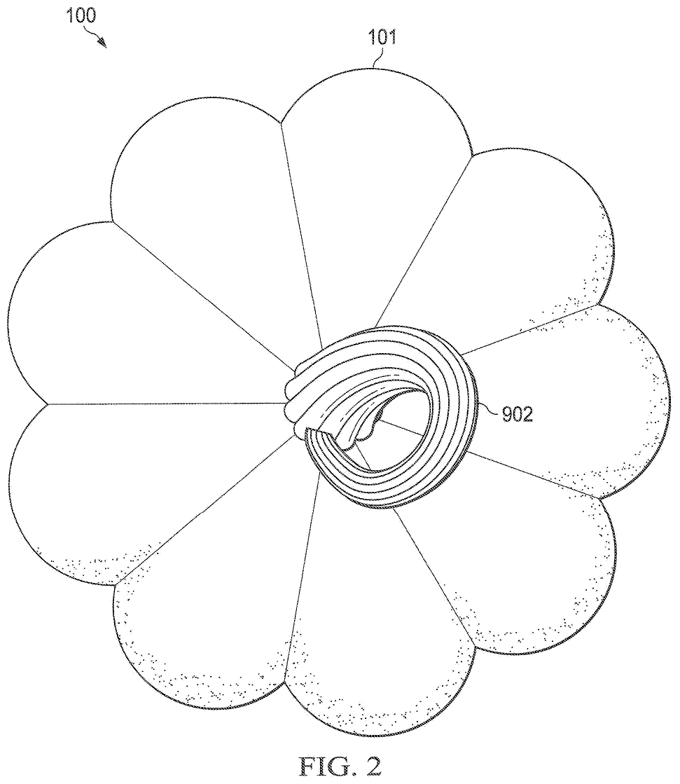

FIG. 2 is a top view of the first embodiment of the invention 100 showing inflatable pumpkin shaped globe portion 101 having an average equatorial circumference of between 6 inches and 120 inches and a stem portion 902 of stem plug 900.

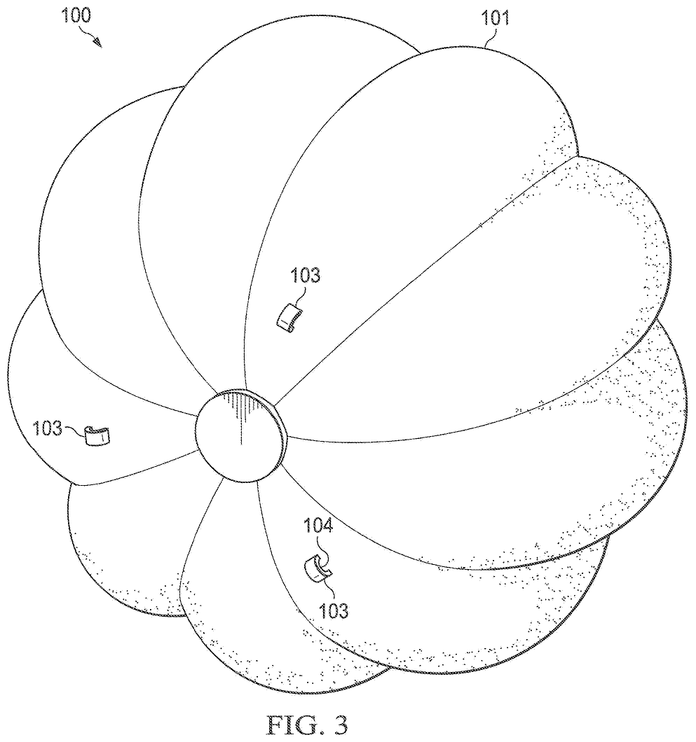

FIG. 3 is a bottom, perspective view of the first embodiment of the invention 100. The inflatable pumpkin shaped globe 101 has a plurality of protrusions or feet 103 proximate the base or lower portion of the inflatable pumpkin shaped globe 101. Said protrusions have protrusion apertures 104 traversing through the planar surfaces thereof for use to thread a string, wire or similar item therethrough to stake the invention 100 to the ground.

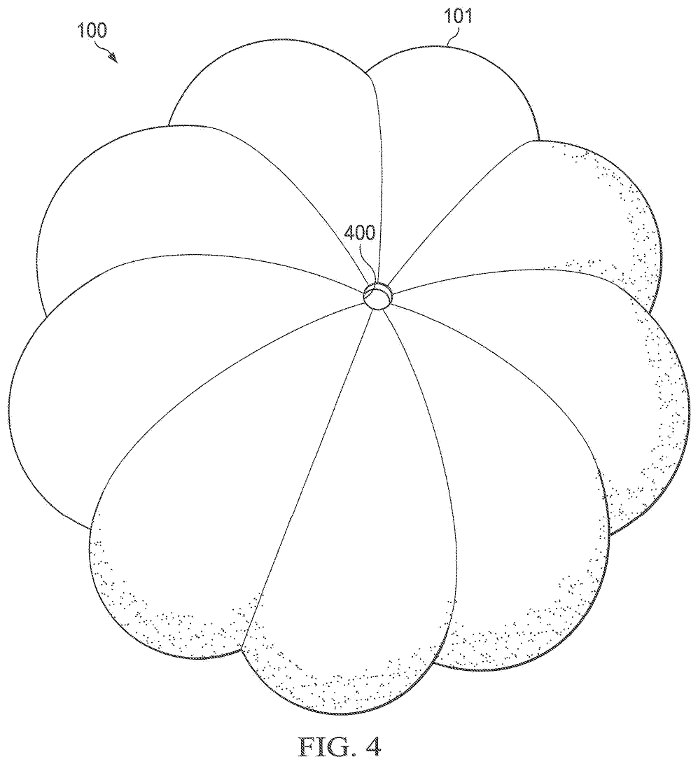

FIG. 4 is a top, perspective view of the second embodiment of the invention showing the stem plug 900 removed from the inflatable pumpkin. Closure mechanism comprises an aperture 400 operable to receive stem plug 900 and to retain air in the inflatable pumpkin shaped globe 101 and comprises stem plug 900 and aperture 400. Aperture 400 traverses the wall of the inflatable pumpkin shaped globe 101, the aperture 400 operable to allow ingress into the interior of the inflatable pumpkin shaped globe 101.

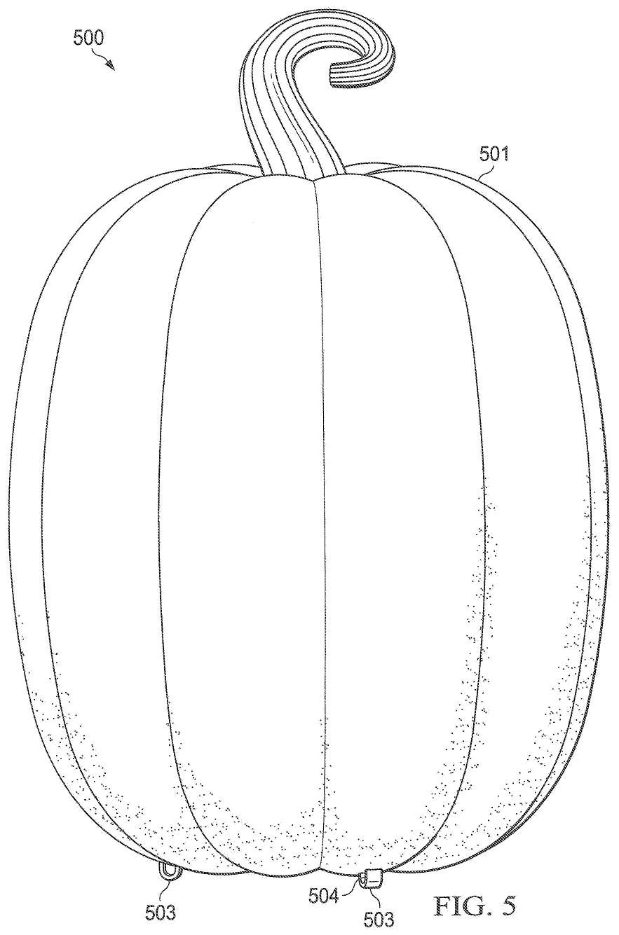

FIG. 5 is a side-view of a second embodiment of the invention 500 providing a more prolate spheroid shape of the inflatable globe 501. As seen therein, the invention 500 is a holiday apparatus, comprising an inflatable pumpkin shaped globe portion 501 having an average equatorial circumference of between 6 inches and 120 inches. The inflatable pumpkin shaped globe 501 has a plurality of protrusions 503 proximate the lower portion of the inflatable pumpkin shaped globe 501, said protrusions having protrusion apertures 504 traversing through the planar surfaces thereof.

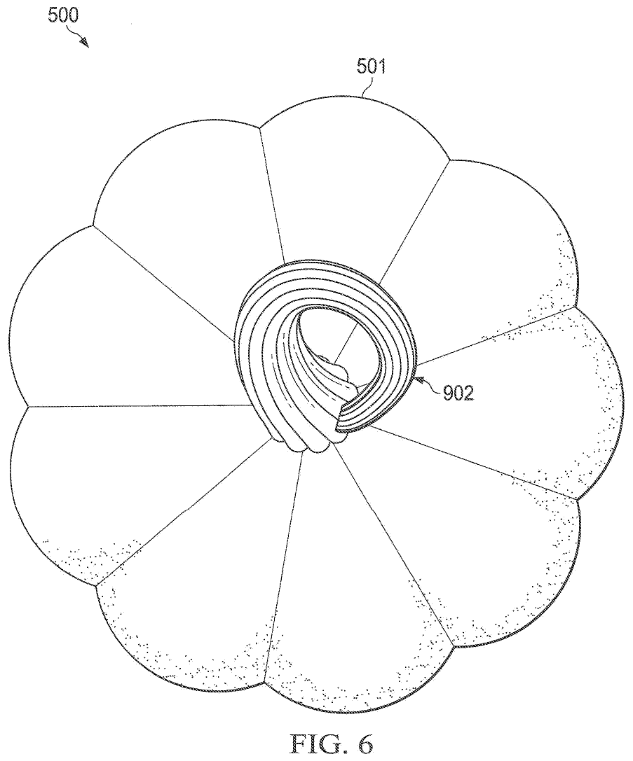

FIG. 6 is a top view of the second embodiment of the invention 500 showing inflatable globe 501 and stem portion 902 of stem plug 900 (as seen in FIG. 9) installed thereon.

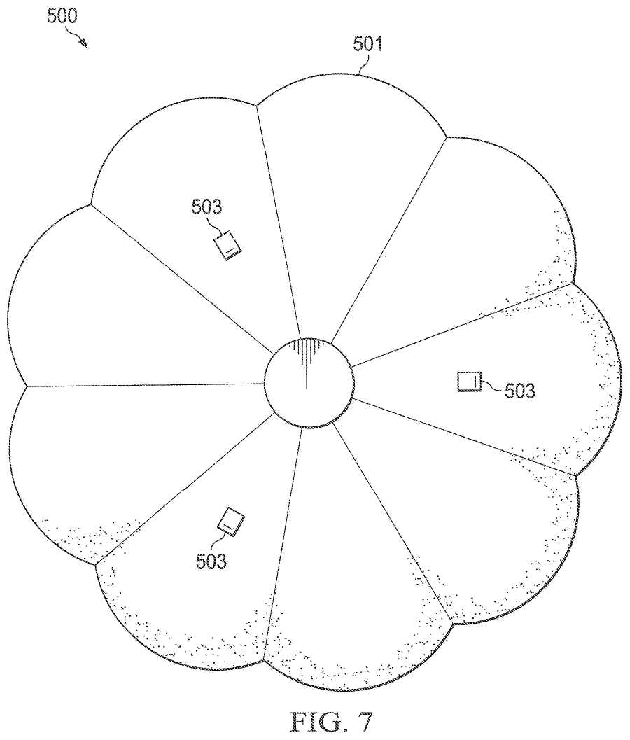

FIG. 7 is a bottom view of the second embodiment of the invention 500. The inflatable pumpkin shaped globe 501 has a plurality of protrusions or feet 503 proximate the base or lower portion of the inflatable pumpkin shaped globe 501. Said protrusions have protrusion apertures 504 (seen in FIG. 5) traversing through the planar surfaces thereof for use to thread a string, wire, cord or similar item therethrough to stake the invention 500 to the ground.

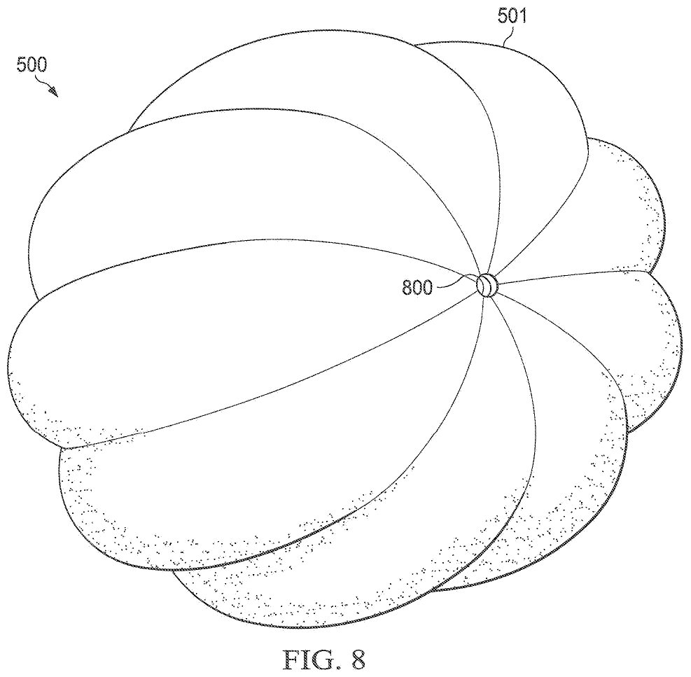

FIG. 8 is a top view of the first embodiment of the invention 500 showing the stem plug 900 removed from the inflatable pumpkin. Closure mechanism comprises an aperture 800 operable to receive stem plug 900 and to retain air in the inflatable pumpkin shaped globe 501 and comprises stem plug 900 and aperture 800. Aperture 800 traverses the wall of the inflatable pumpkin shaped globe 101, the aperture 800 operable to allow ingress into the interior of the inflatable pumpkin shaped globe 501.

FIG. 9 is a view of a stem plug 900 used as part of the closure mechanism. Stem plug 900 has a ribbed portion 901 and a stem portion 902 formed as a curled loop. In an alternative embodiment, ribbed portion 901 can be a smooth graduated spear portion or a threaded portion. In an embodiment, the base of the stem plug 900 above the ribbed portion 901 is between 3 inches and 25 inches in height and a diameter dimension of between 1 inches and 10 inches.

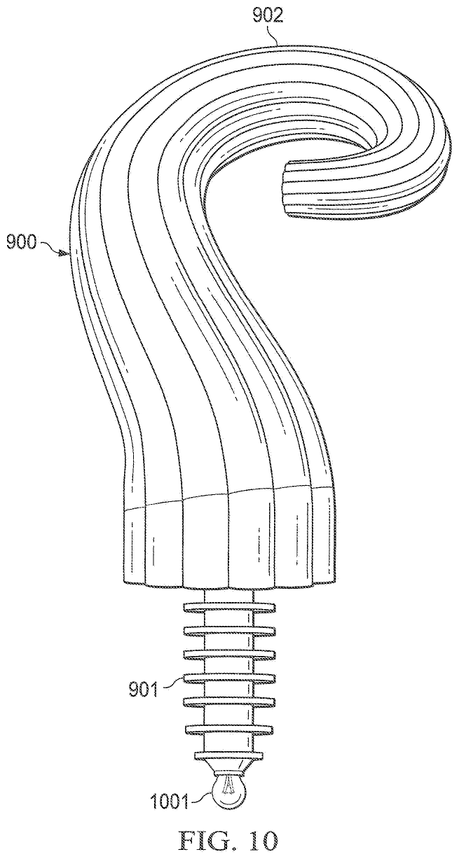

FIG. 10 is a view of a stem plug 900 used as part of the closure mechanism. Stem plug 900 has a ribbed portion 901 and a stem portion 902 and a light source 1001. In an alternative embodiment, ribbed portion 901 can be a smooth graduated spear portion or a threaded portion. In an embodiment, the base of the ribbed stem plug 900 above the ribbed portion 901 has a height dimension of between 3 inches and 25 inches and a diameter dimension of between 1 inches and 10 inches.

The invention is a holiday apparatus, comprising an inflatable pumpkin shaped globe having an average equatorial circumference of between 6 inches and 120 inches; an aperture that traverses the wall of the inflatable pumpkin shaped globe, the aperture allowing ingress into the interior of the inflatable pumpkin shaped globe; and a closure mechanism that securely couples to the aperture into the inflatable pumpkin shaped globe operable to retain air in the inflatable pumpkin shaped globe when closed.

The inflatable pumpkin shaped globe is made of a resilient polymer material. The inflatable pumpkin shaped globe more specifically is a three-dimensional spheroid shape characterized by a round or oval shape with no sharp edges or corners, said inflatable pumpkin shaped globe having a plurality of protrusions proximate the lower portion of the inflatable pumpkin shaped globe, said protrusions having protrusion apertures traversing through the planar surfaces thereof. The inflatable pumpkin shaped globe further comprises a plurality of indentations, ribs or ridges along the longitudinal surface thereof extending from the top to the bottom of the inflatable shaped pumpkin, giving it a segmented appearance. An indentation is a deep recess or notch on the edge or surface of something. The inflatable pumpkin shaped globe further comprises a plurality of indentations, ribs or ridges that are longitudinal sections or protrusions formed along the surface of the pumpkin.

The closure mechanism comprises a plug. The aperture is an inwardly cylindrical portion of the inflatable pumpkin shaped globe extends into the interior of the inflatable pumpkin shaped globe and the closure mechanism is a plug that is received into the aperture. In an embodiment, the plug is ribbed. In a further embodiment, the plug is threaded.

The invention further includes a light source for illuminating the interior of the inflatable pumpkin shaped globe. In an embodiment, the light source is coupled to an end of the plug.

In a further embodiment, the inflatable pumpkin shaped globe has a spheroid portion and a stem portion, and wherein the light source is within the stem portion wherein the light source is a Light-Emitting Diode (LED). The LED can be controlled by either a local switch, a wired controller or a wireless controller. The light source can be powered by one selected from the group consisting of an internal battery, external battery unit and solar panel.

In an embodiment, the closure mechanism is a plug having a cylindrical rod portion and a top portion having an aperture therethrough, the cylindrical rod portion having helical ridges (threads) spiraling around its length on its outer surface wherein the threads are uniformly spaced and are designed to match with corresponding threads in the inwardly cylindrical portion of the inflatable pumpkin shaped globe which extends into the interior of the inflatable pumpkin shaped globe.

In an embodiment, the closure mechanism is a stem plug having a ribbed portion at a proximate end thereof and a stem portion at a distal end thereof. The ribbed portion has ridges, ribs or helical ridges (threads) spiraling around its length on its outer surface. In the thread embodiment, the threads are uniformly spaced and are designed to match with corresponding threads in the inwardly cylindrical portion of the inflatable pumpkin shaped globe which extends into the interior of the inflatable pumpkin shaped globe.

The inflatable pumpkin shaped globe is a resilient polymer material having incorporated into the material dye or coloring.

The invention further is a decorative holiday apparatus, comprising an inflatable pumpkin shaped globe made of a resilient polymer material having a colored surface and having an average equatorial circumference of between 6 inches and 120 inches; an opening that coaxially traverses the wall of the inflatable pumpkin shaped globe, the opening allowing ingress into the interior of the inflatable pumpkin shaped globe; and a closure mechanism that securely couples to the opening into the inflatable pumpkin shaped globe operable to retain air in the inflatable pumpkin shaped globe when closed. The inflatable pumpkin shaped globe has a spheroid portion and a stem portion and is made of a resilient polymer material and the closure mechanism comprises a plug and a corresponding inwardly cylindrical portion of the inflatable pumpkin shaped globe which extends into the interior of the inflatable pumpkin shaped globe, the plug operable to mate with the inwardly cylindrical portion so as to retain air in the inflatable pumpkin shaped globe when it is closed.

The invention is an inflatable, resilient, plastic polymer ellipsoid, oval or pumpkin shaped globe for use as a holiday decoration. More specifically, the invention is a holiday apparatus, comprising an inflatable ellipsoid, oval or pumpkin shaped globe with an average equatorial circumference of between 6 inches and 120 inches with an opening allowing ingress into the interior of the ellipsoid, oval or pumpkin globe. A closure mechanism securely couples to opening into the inflatable ellipsoid, oval or pumpkin globe thus restricting the egress of air from the inflatable ellipsoid, oval or pumpkin globe. Without limiting the materials used to make the invention in an embodiment, the inflatable globe is made of a resilient polymer material. The opening into the inflatable ellipsoid, oval or pumpkin globe can be a cylindrical orifice being a conduit into the interior of the ellipsoid, oval or pumpkin globe. The closure mechanism couples to the attachment pin at the top of the inflatable ellipsoid, oval or pumpkin globe. Alternatively, the opening is an inwardly cylindrical portion of the inflatable ellipsoid, oval or pumpkin globe that extends into the interior of the inflatable ellipsoid, oval or pumpkin globe and the closure mechanism is a plug that is received into the opening. A light source can be located at an end of said plug, said light source being a compact electric light source such as a Light-Emitting Diode and powered by one from the group consisting of an internal battery, external battery unit and solar panel via wires extending through said attachment pin. Further, the closure mechanism can comprise a threaded portion configured to be coupled to the integrated attachment pin. The inflatable ellipsoid, oval or pumpkin globe can be any color, preferably orange for the pumpkin, and can be monochromatic or having a pattern of a plurality of colors.

The invention further comprises an inflatable ellipsoid, oval or pumpkin globe having a generally ellipsoid, oval or pumpkin shape an average equatorial circumference of between 6 inches and 120 inches and an opening into the interior of the globe located at the top of said inflatable ellipsoid, oval or pumpkin globe. A removable ribbed plug is configured to be received into the opening in the top or the bottom of said ellipsoid, oval or pumpkin globe having stopper near its terminal end, and an aperture at its upper end, the ribbed plug operable to maintain air pressure in said inflatable ellipsoid, oval or pumpkin globe when inserted. In an embodiment. The ribbed plug is integrated into and is part of the stem of the invention.

This embodiment of the invention further comprises a light source at a distal end of said removable ribbed plug, said light source being a compact electric light source such as a Light-Emitting Diode and wherein said light source is powered by one from the group consisting of an internal battery, external battery unit and solar panel via wires extending through said attachment pin. A further embodiment of the invention is an inflatable holiday apparatus, comprising an inflatable ellipsoid, oval or pumpkin globe with an attachment pin, said attachment pin extending a short distance through a threaded or ridged opening on the top of said inflatable ellipsoid, oval or pumpkin globe such that one end of said attachment pin defined as the interior end is inside said ellipsoid, oval or pumpkin globe when assembled, said attachment pin comprising a threaded section corresponding to said threaded or ridged opening on the top of said inflatable ellipsoid, oval or pumpkin globe. Said embodiment further includes a hanger, and a light source at said interior end of said attachment pin, said light source being a compact electric light source such as a Light-Emitting Diode wherein said light source is powered by one from the group consisting of an internal battery, external battery unit and solar panel via wires extending through said attachment pin.

An advantage of the invention is that it can be inflated to a diameter of several feet or meters and then be deflated after use to allow for efficient storage. The invention includes an ultraviolet (UV) resistant coating, and is durable for use in any weather condition. The invention is preferably inflated with an electric fast flow inflator.

More generally, the invention is a holiday apparatus comprising an inflatable ellipsoid, oval or pumpkin globe having a generally round shape and an average equatorial circumference of between 6 inches and 120 inches. When plugged, the ellipsoid, oval or pumpkin globe is impervious to the release of air that is injected therein prior to plugging. An attachment pin is attached or coupled to the top or bottom of the globe for accepting a closure mechanism. A hanger can be threaded through an orifice at the end of the closure mechanism.

The inflatable ellipsoid, oval or pumpkin globe is preferably made of a resilient polymer material. The hanger that is threaded through the plug is made from a material selected from the group consisting of steel, plastic, string, cord or similar material. The ellipsoid, oval or pumpkin globe is monochromatic or can be comprised of a plurality of colors. Preferably, the pumpkin globe is primarily an orange color.

In an embodiment the inflatable ellipsoid, oval or pumpkin further comprises an electronic light such as an LED suspended therein, said light being powered by a replaceable or rechargeable battery, or solar panel or other external power source. In an embodiment, said light is coupled to a switch and can be set to on or off. In another embodiment, said light is coupled via a wireless receiver to a remote control and can be set to on or off using said remote. In a further embodiment, the inflatable ellipsoid, oval or pumpkin comprises multiple lights such as LEDs suspended therein, said lights emitting different or varied colors, and the desired emitted light color can be controlled via said switch or remote by mixing the intensity of the individual lights.

The invention is a holiday apparatus, comprising an inflatable ellipsoid, oval or pumpkin globe having a generally round shape an equatorial circumference of between 6 inches and 120 inches; an opening allowing ingress into the interior of the globe; a closure mechanism that securely couples to opening into the inflatable ellipsoid, oval or pumpkin globe thus restricting the egress of air from the inflatable globe. The inflatable ellipsoid, oval or pumpkin globe is made of a resilient polymer material. The opening is a cylindrical orifice being a conduit into the interior of the ellipsoid, oval or pumpkin globe and the closure mechanism is a removable ribbed plug configured to be received into the opening in the top of said ellipsoid, oval or pumpkin globe, said ribbed plug having stopper near its terminal end, and an aperture at its upper end, the ribbed plug operable to maintain air pressure in said inflatable ellipsoid, oval or pumpkin globe when inserted. The opening is an inwardly cylindrical portion of the inflatable ellipsoid, oval or pumpkin globe that extends into the interior of the inflatable globe and the closure mechanism is a ribbed plug that is received into the opening. The invention further comprises a light source at an end of said plug, said light source being a compact electric light source such as a Light-Emitting Diode. Said light source is powered by one from the group consisting of an internal battery, external battery unit and solar panel via wires extending through said ribbed plug. In an embodiment, the closure mechanism is threaded and the hanger is a closed loop made from one selected from the group consisting of steel, plastic, string, and cord.

In a further embodiment, a light source such as a light emitting diode can be positioned at the end of the plug and powered by an internal or external power source. The inflated ornament can then be illuminated and hung to a tree or tethered to the ground. The illumination is further adapted to be controlled by a local switch or timer. Illumination can also be controlled by a remote device such as a standalone unit or smartphone running a dedicated application, control signals being sent to electronics integrated into said attachment pin by wireless means such as 2.4 GHz radio or Bluetooth™, said integrated electronics including a receiving antenna, non-volatile memory, and processor capable of running a program in the form of instructions stored in said memory.

In an embodiment the inflatable ornament further comprises an electronic light such as an LED suspended therein, said light being powered by a replaceable or rechargeable battery, or solar panel or other external power source. In an embodiment, said light is coupled to a switch and can be set to on or off. In another embodiment, said light is coupled via a wireless receiver to a remote control and can be set to on or off using said remote. In a further embodiment, the inflatable pumpkin comprises multiple lights such as LEDs suspended therein, said lights emitting different or varied colors, and the desired emitted light color can be controlled via said switch or remote by mixing the intensity of the individual lights.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the disclosed invention without departing in any way from the spirit and scope of the invention.

The invention claimed is:

1. A holiday apparatus, comprising an inflatable pumpkin shaped globe having an average equatorial circumference of between 6 inches and 120 inches; and
a closure mechanism comprising a plug and a corresponding aperture providing access into the inflatable pumpkin shaped globe, the plug, when inserted into the aperture, operable to fit securely fit therein so as to retain air in the inflatable pumpkin shaped globe.

2. The holiday apparatus of claim 1, wherein the inflatable pumpkin shaped globe is made of a resilient polymer material.

3. The holiday apparatus of claim 1, wherein the inflatable pumpkin shaped globe more specifically is a three-dimensional spheroid shape characterized by a round or oval shape with no sharp edges or corners, said inflatable pumpkin shaped globe having a plurality of protrusions or feet proximate the lower portion of the inflatable pumpkin shaped globe.

4. The holiday apparatus of claim 3, wherein the inflatable pumpkin shaped globe further comprising a plurality of indentations, ribs or ridges along the longitudinal surface thereof extending vertically from the top to the bottom of the inflatable shaped pumpkin, giving it a segmented appearance.

5. The holiday apparatus of claim 3, wherein the inflatable pumpkin shaped globe further comprises a plurality of indentations, ribs or ridges that are longitudinal sections or protrusions formed along the surface of the pumpkin.

6. The holiday apparatus of claim 1, wherein the plug comprises a stem plug having a curved stem portion at a proximate end thereof and a ribbed portion at a distal end thereof.

7. The holiday apparatus of claim 1, wherein the aperture is an inwardly cylindrical portion of the inflatable pumpkin shaped globe which extends into the interior of the inflatable pumpkin shaped globe and the plug is a stem plug having a curved stem portion and a ribbed portion, the ribbed portion being dimensioned to be received into the aperture.

8. The holiday apparatus of claim 1, wherein the plug is a stem plug having a threaded portion at a proximate end thereof and a stem portion at a distal end thereof, the threaded portion dimensioned to fit securely into the corresponding aperture, the aperture having corresponding threads.

9. The holiday apparatus of claim 8, wherein the stem plug has a threaded portion having helical ridges (threads) spiraling around its length on its outer surface dimensioned to match with corresponding threads in the aperture, the aperture having an inwardly cylindrical portion which extends into the interior of the inflatable pumpkin shaped globe.

10. The holiday apparatus of claim 1, in combination with a light source for illuminating the interior of the inflatable pumpkin shaped globe.

11. The holiday apparatus of claim 10, wherein the light source is within the inflatable pumpkin shaped globe.

12. The holiday apparatus of claim 10, wherein the inflatable pumpkin shaped globe has a spheroid portion and a stem plug, and wherein the light source is incorporated with the stem plug.

13. The holiday apparatus of claim 10, wherein the light source is a Light-Emitting Diode (LED).

14. The holiday apparatus of claim 13, wherein the LED is controlled by either a local switch, a wired controller or a wireless controller.

15. The holiday apparatus of claim 14, wherein said light source is powered by one selected from the group consisting of an internal battery, external battery unit and solar panel.

16. The holiday apparatus of claim 1, wherein the closure mechanism is a plug having a cylindrical rod portion and a top portion having an aperture therethrough, the cylindrical rod portion having helical ridges (threads) spiraling around its length on its outer surface; and
wherein the threads are uniformly spaced and are designed to match with corresponding threads in the inwardly cylindrical portion of the inflatable pumpkin shaped globe which extends into the interior of the inflatable pumpkin shaped globe.

17. The holiday apparatus of claim 1, wherein the inflatable pumpkin shaped globe is a resilient polymer material having incorporated into the material dye or coloring.

18. A decorative holiday apparatus, comprising an inflatable pumpkin shaped globe made of a resilient polymer material having a colored surface and having an average equatorial circumference of between 6 inches and 120 inches;
an opening that coaxially traverses the wall of the inflatable pumpkin shaped globe, the opening allowing ingress into the interior of the inflatable pumpkin shaped globe; and
a closure mechanism that securely couples to the opening into the inflatable pumpkin shaped globe operable to retain air in the inflatable pumpkin shaped globe when closed.

19. The decorative holiday apparatus of claim 18, wherein the inflatable pumpkin shaped globe has a spheroid portion and a stem plug portion.

20. The decorative holiday apparatus of claim 19, wherein the closure mechanism comprises a ribbed stem plug and a corresponding inwardly cylindrical portion of the inflatable pumpkin shaped globe which extends into the interior of the inflatable pumpkin shaped globe, the ribbed stem plug operable to mate with the inwardly cylindrical portion so as to retain air in the inflatable pumpkin shaped globe when securely inserted therein.
